(19) United States
(12) Patent Application Publication
(10) Pub. No.: US 2026/0163155 A1
(43) Pub. Date: Jun. 11, 2026

(54) SYSTEM AND METHOD FOR PROVIDING MILEAGE RANGE EXTENSION FOR ELECTRIC VEHICLES USING RECHARGEABLE MODULAR BATTERY CELLS

(71) Applicant: Yemao Huang, Longwood, FL (US)

(72) Inventor: Yemao Huang, Longwood, FL (US)

(21) Appl. No.: 18/975,668

(22) Filed: Dec. 10, 2024

(51) Int. Cl. H01M 50/249; B60L 53/80; H01M 10/42; H01M 50/233; H01M 50/262; H01M 50/505

(52) U.S. Cl. CPC H01M 50/249; B60L 53/80; H01M 10/425; H01M 50/233; H01M 50/262; H01M 50/505; H01M 2010/4271

(57) ABSTRACT

In one or more embodiments, systems and methods for providing mileage range extension using rechargeable modular battery cells for electric vehicles are disclosed. The system for providing mileage range extension for an electric vehicle includes a frame having a plurality of shelflike cavities, wherein each of the plurality of shelflike cavities is configured to hold one or more rechargeable modular battery cells, and wherein each of the plurality of shelflike cavities includes a lockable access door; wherein each of the plurality of shelflike cavities is provided with one or more connection points; and wherein each of the one or more rechargeable modular battery cells is removably attached to one or more of the other rechargeable modular battery cells in series or in parallel depending on the voltage configuration using the one or more connection points to form a battery-pack unit capable of powering the electric vehicle.

### FIELD OF THE INVENTION

The embodiments described herein relate generally to providing mileage range extension for electric vehicles and more particularly to providing mileage range extension mechanism using rechargeable modular battery cells for electric vehicles.

### SUMMARY

In one or more embodiments, systems, and methods for providing mileage range extension using rechargeable modular battery cells for electric vehicles are disclosed.

In one or more embodiments, the system for providing mileage range extension for an electric vehicle using one or more rechargeable modular battery cells, wherein the system includes a frame having a plurality of shelflike cavities, wherein each of the plurality of shelflike cavities is configured to hold one or more rechargeable modular battery cells, and wherein each of the plurality of shelflike cavities includes a lockable access door; wherein each of the plurality of shelflike cavities is provided with one or more connection points; and wherein each of the one or more rechargeable modular battery cells is removably attached to one or more of the other rechargeable modular battery cells in series or in parallel depending on the voltage configuration using the one or more connection points to form a battery-pack unit capable of powering the electric vehicle.

In one or more embodiments, the method for providing mileage range extension for an electric vehicle using one or more rechargeable modular battery cells, wherein the method includes: providing a frame having a plurality of shelflike cavities, wherein each of the plurality of shelflike cavities is configured to hold one or more rechargeable modular battery cells, and wherein each of the plurality of shelflike cavities includes a lockable access door; and providing one or more connection points for removably attaching each of the one or more rechargeable modular battery cells to one or more of the other rechargeable modular battery cells in series or in parallel depending on the voltage configuration to form a battery-pack unit capable of powering the electric vehicle.

### BRIEF DESCRIPTION OF THE DRAWINGS

FIG. 1A illustrates an example system for providing mileage range extension using rechargeable modular battery cells for electric vehicles according to one or more embodiments described herein.

FIG. 1B illustrates an example system for providing mileage range extension using rechargeable modular battery cells for electric vehicles according to one or more embodiments described herein.

FIGS. 2A, 2B, 2C and 2D illustrate example systems for providing mileage range extension using rechargeable modular battery cells for electric vehicles according to one or more embodiments described herein.

FIGS. 3A and 3B illustrate example system components for providing mileage range extension using rechargeable modular battery cells for electric vehicles according to one or more embodiments described herein.

FIGS. 4A-4D illustrate example system components for providing mileage range extension using rechargeable modular battery cells for electric vehicles according to one or more embodiments described herein.

FIGS. 4E-4H illustrate example system components for providing mileage range extension using rechargeable modular battery cells for electric vehicles according to one or more embodiments described herein.

FIGS. 5A-5C illustrate an exemplary method for providing mileage range extension using rechargeable modular battery cells for electric vehicles according to one or more embodiments described herein.

### DETAILED DESCRIPTION

The embodiments described herein relate generally to providing mileage range extension for electric vehicles and more particularly to providing mileage range extension using rechargeable modular battery cells for electric vehicles.

The following description is presented to enable one of ordinary skill in the art to make and use the invention and is provided in the context of a patent application and its requirements. Various modifications to the preferred embodiments and the generic principles and features described herein will be readily apparent to those skilled in the art. Furthermore, various embodiments may be combined as those skilled in the art can reasonably conclude that the inventor had possession of the claimed invention regarding the various combinations of the embodiments. Thus, the present invention is not intended to be limited to the embodiments shown but is to be accorded the widest scope consistent with the principles and features described herein.

The Electric Vehicle (EV) manufacturers are trying to design a single battery with a range of 300-400 miles. Even with such a large battery pack providing a range 300-400 miles, the EV owners may still have range anxieties. This may be due to limited availability of charging stations and/or long charging times, for example, super charging stations such as the ones provided by Tesla, take at least 30 minutes to charge to 80% full, even though average EV owner only drives 35-50 miles a day. The system and method provided herein may also reduce the need to supercharge, as high voltage supercharging may reduce the battery life.

Study shows that 46% of EV owners want to switch back to combustion engines vehicles because of long wait for charging and inconvenience of charging causing range anxiety problems. Smaller rechargeable modular battery cells may act as movable energy flow just like gasoline or propane, that could be easily distributed to many locations for EV drivers to add or swap. Rechargeable modular battery cells could also be interchangeable with solar batteries at home to utilize solar energy. Many manufacturers already developing bi-directional home charging to use EV batteries as home power source.

Thus, Modular Battery Cell Vehicle to Grid/Load (V2G/V2L) integration could dramatically change the energy use in the U.S. It could help people's lives and may also lead to reduced cost of home building and infrastructure.

The method and system described here thus provides mileage range extension for an electric vehicle using one or more rechargeable modular battery cells as an easy energy flow to avoid inconvenient charging, long wait of charging causing range anxiety problems, without compromising efficacy of use as well as safety of the electric vehicle similar to turbo energy recycling.

Modularizing the battery cells may also allow energy recycling. For example, when EV batteries discharge due to high acceleration, they create tremendous heat. Between expansion slots, heat exchange gaps for thermal management may be added via air or liquid. That energy of discharging heat could be recycled back to charge batteries or to add to the electrical vehicles.

With the embodiments described herein, EV manufacturers may only need to provide a smaller battery pack that provides up to 200-mile range of battery capacity. The newly designed rechargeable modular battery cells can be standardized and can be made available at any gas stations, charge stations, convenient stores, parking lots . . . etc. because of smaller size, ease of transportation and rechargeable feature. Expansion slots, also referred to herein as shelflike cavities, will allow the EV owners the freedom of buying an EV at a lower cost and customize their EV's mileage range at any time by adding or swapping fully charged standard rechargeable modular battery cells independent of the original mileage range by either purchasing or renting the fully charged standard rechargeable modular battery cells.

Rechargeable modular battery cells dimensions, voltage, capacity grade, etc. may be standardized for mass production between different manufacturers to reduce the cost of production and may also be integrated with clean and renewable power generation systems, for example, Solar/Wind/Hydro, for off the grid independence.

Current cost of production for an undivided battery-pack is approximately $150 per kWh, so the current EV battery pack of 100 KWH cost is about $ 15,000, however, with rechargeable modular battery cells, the cost of the battery calls can be much lower. For example, if it is assumed for the sake of calculations that each rechargeable modular battery cell costs $100 per kWh, the 12 original factory battery cells cost may only be 62×100=$6,200. This cost efficiency in production may be possible because of the smaller size of the modular cell and the mass production of the smaller modular battery cells. The cost may be further reduced with better availability of the modular battery cells if the entire industry starts using the same standard size. The standardization of the rechargeable modular battery cells may include any one or more of: dimensions, voltage, capacity grade, etc.

The following embodiments described herein are unique and improved methods/systems that provide the mileage range extension for electric vehicles and more particularly to providing mileage range extension using rechargeable modular battery cells for electric vehicles to solve EV's range and convenience issues.

In one or more embodiments, systems, and methods for providing mileage range extension using rechargeable modular battery cells for electric vehicles are disclosed.

In one or more embodiments, the system for providing mileage range extension for an electric vehicle using one or more rechargeable modular battery cells, wherein the system includes a frame having a plurality of shelflike cavities, also referred to herein as expansion slots, wherein each of the plurality of shelflike cavities is configured to hold one or more rechargeable modular battery cells, and wherein each of the plurality of shelflike cavities includes a lockable access door; wherein each of the plurality of shelflike cavities is provided with one or more connection points; and wherein each of the one or more rechargeable modular battery cells is removably attached to one or more of the other rechargeable modular battery cells in series or in parallel depending on the voltage configuration using the one or more connection points to form a battery-pack unit capable of powering the electric vehicle.

In any one or more embodiments described herein, the frame having a plurality of shelflike cavities may be provided as any one or more of: attachable to a vehicle frame of the electric vehicle, as part of the vehicle frame integrated in the vehicle frame, in the cavity of a trunk provided in front of the vehicle, in the cavity of a trunk provided in the back of the vehicle, attached to any part of the electric vehicle that is capable of carrying the frame having a plurality of shelflike cavities with one or more rechargeable modular battery cells.

In any one or more embodiments described herein, the one or more connection points include any one or more of: positive connection point, negative connection point, battery management system (BMS) connection point and balance connection point, to connect each of the one or more rechargeable modular battery cells to any one or more of: one or more of the other rechargeable modular battery cells, central busbar and BMS.

In any one or more embodiments described herein, the lockable access door is configured to allow access to a single rechargeable modular battery cell or a group of rechargeable modular battery cells from either side of the vehicle, or from front or back of the vehicle.

In any one or more embodiments described herein, the lockable access door includes any one or more of: a pullout door, a sliding door or a swing door.

In any one or more embodiments described herein, one or more additional rechargeable modular battery cells can be added to any one or more of the plurality of shelflike cavities to extend the mileage range of the electric vehicle, wherein one or more of the one or more rechargeable modular battery cells are also capable of powering the electric vehicle.

In any one or more embodiments described herein, the one or more rechargeable modular battery cells is removably attached to one or more of the other rechargeable modular battery cells via a central busbar in series or in parallel depending on the voltage configuration to form a battery-pack unit capable of powering the electric vehicle.

In any one or more embodiments described herein, each of the one or more rechargeable modular battery cells is capable of being pulled out for charging or swapping when required.

In any one or more embodiments described herein, each of the one or more rechargeable modular battery cells includes a Lithium Iron Phosphate (LFP) battery that provides at least part of the electricity to power an electric vehicle.

In any one or more embodiments described herein, the one or more rechargeable modular battery cells include of a standard size, including any one or more of: dimensions, voltage, capacity grade, etc. that is removably attached to one or more of the other rechargeable modular battery cells to form a battery pack unit capable of providing a total electrical energy capacity to power and electric vehicle.

In one or more embodiments, the system may further include one or more stackable layers of plurality of shelflike cavities to hold one or more rechargeable modular battery cells depending on the desirable height of the chassis of the vehicle, the trunk in front of the vehicle or the trunk in the back of the vehicle, as well as height of the modular battery cells. This design may provide an extra-long mileage range that can be used for special long-range needs like outdoor work, safari, etc. for example, depending on the number of cavities in each layer, for example, if all extra slots are filled, the mileage range may be extended by three times the original range.

In one or more embodiments, the method for providing mileage range extension for an electric vehicle using one or more rechargeable modular battery cells, wherein the method includes: providing a frame having a plurality of shelflike cavities, wherein each of the plurality of shelflike cavities is configured to hold one or more rechargeable modular battery cells, and wherein each of the plurality of shelflike cavities includes a lockable access door; and providing one or more connection points for removably attaching each of the one or more rechargeable modular battery cells to one or more of the other rechargeable modular battery cells in series or in parallel depending on the voltage configuration to form a battery-pack unit capable of powering the electric vehicle.

In any one or more embodiments described herein, the frame having a plurality of shelflike cavities is provided as any one or more of: attachable to a vehicle frame of the electric vehicle, as part of the vehicle frame integrated in the vehicle frame, in the cavity of a trunk provided in front of the vehicle, in the cavity of a trunk provided in back of the vehicle, attached to any part of the electric vehicle that is capable of carrying the frame having a plurality of shelflike cavities with one or more rechargeable modular battery cells.

In any one or more embodiments described herein, each of the plurality of shelflike cavities is provided with one or more connection points including any one or more of: positive connection point, negative connection point, battery management system (BMS) connection point and balance connection point, to connect each of the one or more rechargeable modular battery cells to any one or more of: one or more of the other rechargeable modular battery cells, central busbar and BMS.

In any one or more embodiments described herein, the lockable access door is configured to allow access to a single rechargeable modular battery cell or a group of rechargeable modular battery cells from either side of the vehicle, or from front or back of the vehicle.

In any one or more embodiments described herein, the lockable access door includes any one or more of: a pullout door, a sliding door or a swing door.

In any one or more embodiments described herein, the method further includes allowing addition of one or more additional rechargeable modular battery cells to any one or more of the plurality of shelflike cavities to extend the mileage range of the electric vehicle, wherein one or more of the one or more rechargeable modular battery cells are also capable of powering the electric vehicle.

In any one or more embodiments described herein, the method further includes providing a central busbar for removably attaching one or more rechargeable modular battery cells to one or more of the other rechargeable modular battery cells via the central busbar in series or in parallel depending on the voltage configuration to form a battery-pack unit capable of powering the electric vehicle.

In any one or more embodiments described herein, the method includes configuring the frame such that each of the one or more rechargeable modular battery cells can be pulled out for charging or swapping when required.

In any one or more embodiments described herein, each of the one or more rechargeable modular battery cells is a Lithium Iron Phosphate (LFP) battery that provides at least part of the electricity to power an electric vehicle.

In any one or more embodiments described herein, the one or more rechargeable modular battery cells may be provided as standard size including any one or more of: dimensions, voltage, capacity grade, etc. modular battery cells that are removably attached to one or more of the other rechargeable modular battery cells to form a battery pack unit capable of providing a total electrical energy capacity to power and electric vehicle.

In any one or more embodiments described herein, the frame having a plurality of cavities is further provided as one or more stackable layers of plurality of shelflike cavities to hold one or more rechargeable modular battery cells depending on the desirable height of the chassis, the trunk in front of the vehicle, or the trunk in the back of the vehicle as well as height of the rechargeable modular battery cells.

The purpose of this device/system and method is to extend the mileage range of an electric vehicle by providing a battery add and/or swap mechanism using rechargeable modular battery cells for electric vehicles to avoid inconvenience of finding charging stations, long wait time for charging causing range anxiety problems, without compromising efficacy of use as well as safety of the electric vehicle. A person skilled in the art may readily understand that this system/method could be utilized in a multitude of configurations and is within the spirit and scope of the present invention described herein.

Although swapping of a single large EV battery-pack is currently available, it is cumbersome and inconvenient to swap the whole battery as only designated swapping stations may offer this service. Such swapping may also require expensive equipment as a single EV battery is too big for humans to handle on their own. The extra cost of the swapping equipment and the difference in the quality of the swapped large single EV battery pack make this very unpopular, impractical and inconvenient. The fear of difference in the quality may stem from the fact that such swapping may not control which EV battery may be used for swapping and the EV owner may be reluctant to swap a newer EV battery with an older EV battery.

The system and method described herein works by dividing the entire electric vehicle (EV) battery into a number of rechargeable modular battery cells if configured as one layer of modular battery cells in the chassis of the vehicle, in the trunk in front of the vehicle, also referred to herein as frunk and the trunk in the back of the vehicle, referred to herein as a trunk, smaller battery size as well standardization of dimensions, voltage and capacity grade, etc. of the modular battery cells may allow EV drivers easily add or swap the battery cells, which may be either purchased or rented, at many possible locations. Fully charged battery cells could be added or swapped into EV's expansion slots or shelflike cavities for the range desired without long wait. Electrical energy now could be used as a flow of energy easily moved around just like gasoline.

The system and method described herein may still allow the whole battery pack unit of the EV, which may be originally provided along with the EV as well as in combination with the additional modular battery cells, to be charged at any charging stations, parking lots or home.

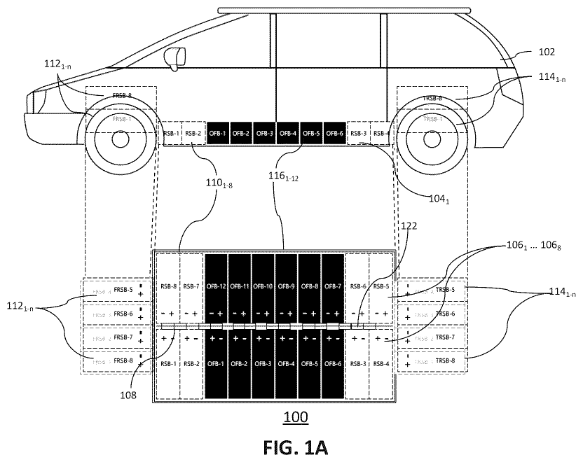

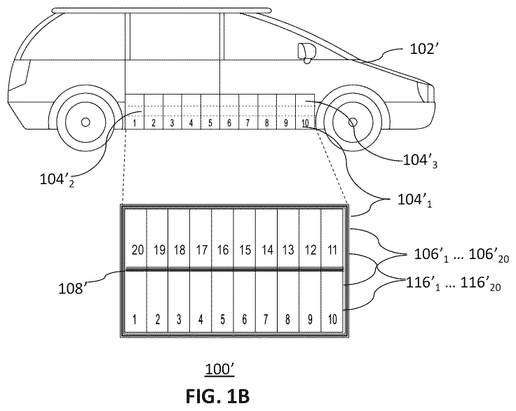

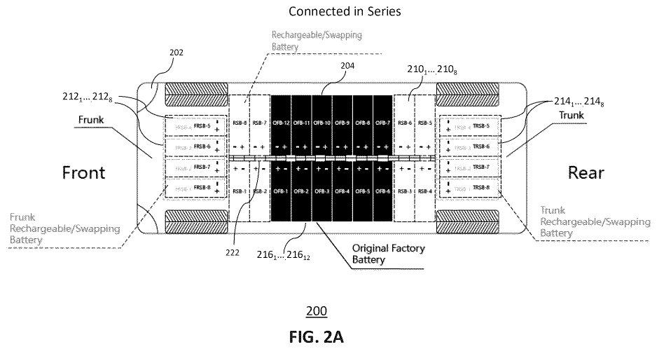

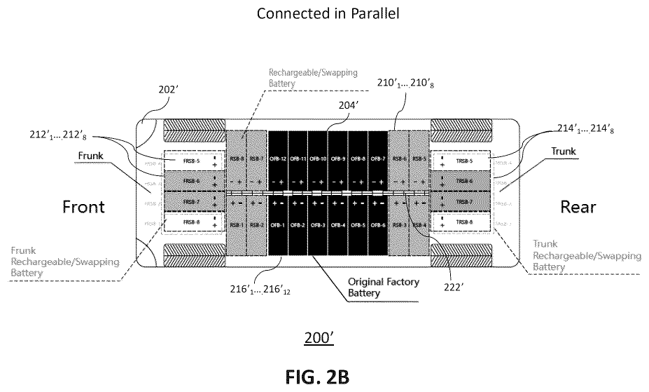

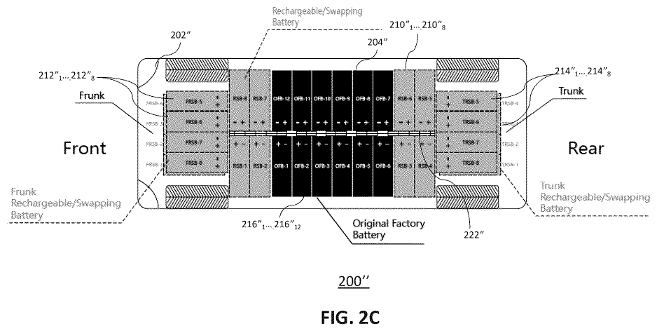

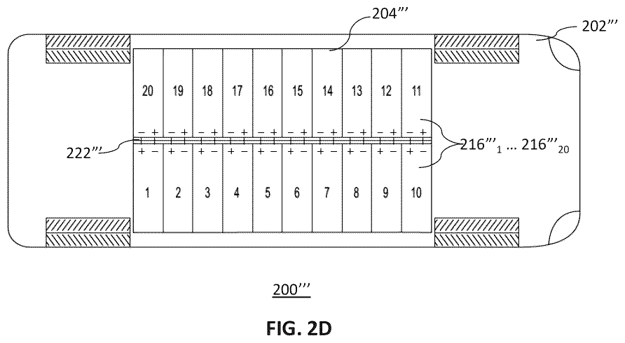

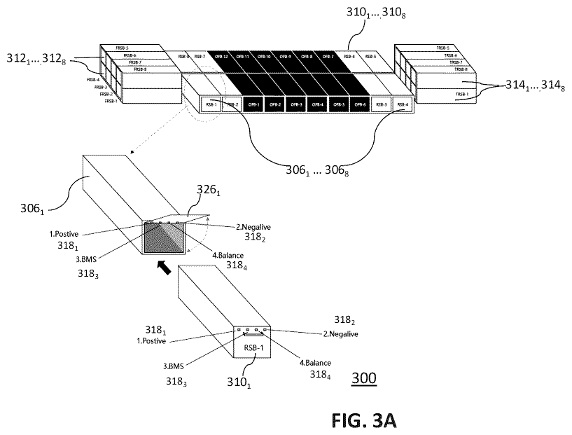

FIG. 1A illustrates a side view of an example system 100 for providing mileage range extension for an electric vehicle using rechargeable modular battery cells according to one or more embodiments described herein. For example, FIG. 1A illustrates a side view of the system 100 for providing mileage range extension for an electric vehicle 102 using one or more rechargeable modular battery cells, also referred to as rechargeable/swapping battery (RSB), 110₁ . . . 110₈ including a frame 104 having a plurality of shelflike cavities, also referred to herein as expansion slots, 106₁ . . . 106₈, and where each of the plurality of shelflike cavities (expansion slots) 106₁ . . . 106₈ may be configured to hold one or more rechargeable modular battery cells, and wherein each of the plurality of cavities includes a lockable access door as illustrated in FIGS. 3A and 3B, and described in detail in the description accompanying FIGS. 3A and 3B; wherein each of the plurality of shelflike cavities is provided with one or more connection points as illustrated in FIG. 3A, and described in detail in the description accompanying FIG. 3A; and wherein each of the one or more rechargeable modular battery cells RSBs 110₁ . . . 110₈ is removably attached to one or more of the other rechargeable modular battery cells RSBs 110₁ . . . 110₈ in series with each other and in series or in parallel with the original factory battery (OFB) cells 116₁ . . . 116₁₂, as illustrated in FIG. 2A, and described in detail in the description accompanying FIG. 2A, using the one or more connection points, for example, the positive connection point and/or the negative connection point, to form a battery-pack capable of powering the electric vehicle 102.

In one or more embodiments, additional expansion slots or shelflike cavities 114₁₋ₙ may be provided in the trunk, 112₁₋ₙ, provided in the front of the electric vehicle, also referred to herein as frunk, and/or in the trunk, 114₁₋ₙ, provided in the back of the electric vehicle 102 respectively.

In any one or more embodiments, the frame, frunk and trunk having a plurality of cavities may be attachable to a vehicle frame or chassis, frunk and trunk of the electric vehicle, or is part of the vehicle frame or chassis, frunk and trunk of the electric vehicle and may have a supporting bar 108 in the center traversing through the length of the frame holding the plurality of rechargeable modular battery cells.

As illustrated in FIG. 1A, the original factory provided battery pack, also referred to as original factory battery (OFB), 116₁₋₁₂ may be also made of modular battery cells and may be replaceable as illustrated in FIG. 1B and described in detail in the description accompanying FIG. 1B.

FIG. 1B illustrates a side view of an example system 100′ for providing mileage range extension for an electric vehicle using rechargeable modular battery cells according to one or more embodiments described herein. For example, FIG. 1B illustrates a side view of the system 100′ for providing mileage range extension for an electric vehicle 102′ using one or more rechargeable modular battery cells including a frame 104′ having a plurality of shelflike cavities, also referred to herein as expansion slots, 106′₁ . . . 106′₂₀, and where each of the plurality of shelflike cavities (expansion slots) 106′₁ . . . 106′₂₀ may be configured to hold one or more rechargeable modular battery cells, and wherein each of the plurality of cavities includes a lockable access door as illustrated in FIG. 3B and described in detail in the description accompanying FIG. 3B; and wherein each of the one or more rechargeable modular battery cells is removably attached to one or more of the other rechargeable modular battery cells in series, as illustrated in FIG. 2D and described in detail in the description accompanying FIG. 2D, to form a battery-pack capable of powering the electric vehicle 102′.

In any one or more embodiments described herein, the system further includes one or more stackable layers 104₁ . . . 104ₙ of plurality of cavities 106₁ . . . 106₈ or 106′₁ . . . 106′₂₀ configured to hold one or more rechargeable modular battery cells depending on the desirable height of the chassis of the vehicle 102 or 102′ as well as height of the rechargeable modular battery cells.

In any one or more embodiments described herein, the frame 104 or 104′ may be provided with one or more lockable access doors that allow access to a single rechargeable modular battery cell or a group of rechargeable modular battery cells placed in shelflike cavities 106₁ . . . 106₈ or 106′₁ . . . 106′₂₀.

In any one or more embodiments described herein, and illustrated in FIGS. 1A and 1B, the lockable access door may be provided as a swing door, a sliding door (not shown) or a pullout door (not shown) as illustrated in FIGS. 3A and 3B, and described in detail in the description accompanying FIGS. 3A and 3B.

In any one or more embodiments described herein, the lockable access door may allow access to a single rechargeable modular battery cell or a group of rechargeable modular battery cells from either side of the vehicle 102 or 102′.

In any one or more embodiments described herein, each of the one or more rechargeable modular battery cells may be removably attached to one or more of the other rechargeable modular battery cells in series or in parallel depending on the voltage configuration via a central busbar 122 as illustrated in FIGS. 2A, 2B, 2C and 2D and described in detail in the description accompanying FIGS. 2A, 2B, 2C and 2D.

In any one or more embodiments described herein, the expansion slots, also referred to herein as shelflike cavities, may be provided with one or more connection points including any one or more of: positive connection point, negative connection point, battery management system (BMS) connection point, and balance connection point as illustrated in FIG. 3A and described in detail in the description accompanying FIG. 3A. The various connection points may be used to connect the modular battery cells with each other and with the vehicle, for example, to connect each of the one or more rechargeable modular battery cells to any one or more of: one or more of the other rechargeable modular battery cells, central busbar, BMS, etc. which may be managed by BMS. The BMS may be used to connect different modular battery cells in different combinations of series and/or parallel connections as groups depending on the voltage configuration to form a battery pack unit capable of powering the electric vehicle.

In any one or more embodiments described herein, each of the one or more rechargeable modular battery cells are capable of being pulled out for charging or swapping when required.

A person skilled in the art may readily understand that although a standard 48-volt, 200-amp battery or a standard 36-volt, 200-amp battery is used as examples for calculations here, batteries with other voltages providing similar functionality may also be used and such use is within the spirit and scope of this invention.

Although, numbering of the factory original rechargeable modular battery cells is described here as 1-12 in that order, with 8 expansion slots available in the chassis; 2 stacks or layers of expansions slots or cavities in the frunk and trunk, for example, each layer may have 4 such modular battery cells, any other number of modular battery cells and cavities and various other arrangements of those modular battery cells and expansion slots referred to herein as cavities that serve the function similar to the one described here is within the spirit and scop of this invention.

A person skilled in the art may readily understand that although a LFP battery is used as an example for calculations here, other types of batteries providing similar functionality, for example, sodium batteries, semi-solid state or solid-state batteries, etc., may also be used and such use is within the spirit and scope of this invention

In any one or more embodiments described herein, the original factory provided rechargeable modular battery cells, installed in series, for example, 12 modular battery cells, where each module or modular battery cell is a 48-volt LFP to form a 576 V battery capable of providing a total electrical energy capacity of 9.2 kWh with 192 Ampere hour (Ah) electrical charge.

Similarly, for example, with one layer of the 12 original factory provided rechargeable 48-volt battery cells installed in series, the total voltage is 576 V, total battery capacity is 110 kWh. The range could be 331 miles assuming an average of 3 miles per kWh. If the number of expansion slots or cavities provided in this example are filled, the mileage range for that EV may be increased to 995 miles. The calculations provided herein are for example for a single layer of modular battery cells, and may be scaled depending on the number of layers, for example, double for 2 layers of stackable modular rechargeable battery cells and triple for 3 layers of stackable modular rechargeable battery cells, etc. as described above.

Similarly, for example, 12 original factory provided rechargeable modular battery cells, where each module or modular battery cell is a 36-volt LFP to form a 432 V battery capable of providing a total electrical energy capacity of 62 kWh with 144 Ah electrical charge.

With one layer of the stackable 36-volt battery cells, the total voltage is 432 V, total battery capacity is 62 kWh. The range could be 186 miles assuming an average of 3 miles per kWh. With the number of expansion slots or cavities provided in this example fully filled, max range could be increased to 560 miles. The calculations provided herein are for example for a single layer of modular battery cells, and may be scaled depending on the number of layers, for example, double for 2 layers of stackable modular rechargeable battery cells and triple for 3 layers of stackable modular rechargeable battery cells, etc. as described above.

In any one or more embodiments described herein, each of the one or more rechargeable modular battery cells is capable of being pulled out for charging or swapping when required.

Although, numbering of the modular battery cells is described here as 1-6 in that order, any other number of rechargeable modular battery cells and expansion slots or cavities and various other arrangements of those battery cells and expansion slots or cavities that serve the function similar to the one described here is within the spirit and scop of this invention.

Similarly, although 2 layers of battery cells are illustrated in FIG. 1B, in any one or more embodiments described herein, the plurality of expansion slots or cavities may be provided in one or more stackable layers depending on the desirable height of the chassis of the vehicle as well as height of the modular battery cells.

Thus, in any one or more embodiments described herein, one or more additional rechargeable modular battery cells can be added to any one or more of the plurality of shelflike cavities (expansion slots) to extend range of the electric vehicle, wherein each one of the one or more rechargeable modular battery cells form the entire EV battery-pack is capable of powering the electric vehicle.

FIGS. 2A, 2B, 2C and 2D illustrate a top view of the systems 200, 200′, 200″ and 200″′ respectively for providing mileage range extension for an electric vehicle using rechargeable modular battery cells for electric vehicle 202 or 202′. The expansion slots, also referred to herein as shelflike cavities, may be provided with one or more connection points including any one or more of: positive connection point, negative connection point, battery management system (BMS) connection point, and balance connection point as illustrated in FIG. 3A. The various connection points may be used to connect the modular battery cells with each other and with the vehicle, for example, to connect each of the one or more rechargeable modular battery cells to any one or more of: one or more of the other rechargeable modular battery cells, central busbar, BMS, etc., which may be managed by BMS. The BMS may be used to connect different modular battery cells in different combinations of series and/or in parallel connections as groups depending on the voltage configuration to form a battery pack unit capable of powering the electric vehicle.

For example, as illustrated in FIG. 2A, in one or more embodiments, each of the one or more modular battery cells 210₁ . . . 210₈ is removably attached to one or more of the other modular battery cells in series via a central busbar 222. FIG. 2A illustrates an example of original factory battery (OFB) cells 216₁ . . . 216₁₂ connected in series. In an example, the factory may only provide 12 48-volt 100 Ampere OFB cells with a total of 576 volts with approximately 62 KWH of capacity (5.12 KWH×12=61.44 KWH) to reach about 200 miles range. In an embodiment, each of the 12 OFB cells may be pulled out of cavities for individual charging/maintenance/repair freely.

Similarly, as illustrated in FIG. 2B, in one or more embodiments, each of the one or more modular battery cells 210′₁ . . . 210′₈ is removably attached to one or more of the other modular battery cells in parallel via a central busbar 222′. FIG. 2B illustrates OFB cells 216′₁ . . . 216′₁₂ used along with extension battery cells (RSB) 210′₁ . . . 210′₈ in the chassis, some of the extension battery cells (RSB) 212′₁ . . . 212′₈ in the Frunk and some of the extension battery cells (RSB) 214′₁ . . . 214′₈ in the Trunk, as illustrated by the shaded area, to reach a mileage range twice of that provided by the OFB cells 216′₁ . . . 216′₁₂.

As illustrated by the shaded area in FIG. 2B, the modular battery cells may be added in the expansion slots, also referred to herein as shelflike cavities, provided on both sides of the vehicle, for example, frunk and trunk, in addition or alternatively to the ones in the chassis, for weight to balance the vehicle, since the modular battery cells may be heavy. This type of addition as illustrated in FIG. 2B may provide 400 miles of total range using 24 modular battery cells, where 12 OFBs are connected in series and additional 12 RSBs are connected in series with each other and in parallel to the OFBs. This connection and utilization of modular battery cells may be managed the BMS, which may be used to connect different modular battery cells in different combinations of series and/or in parallel connections as groups depending on the voltage configuration to form a battery pack unit capable of powering the electric vehicle.

FIG. 2C illustrates OFB cells 216″₁ . . . 216″₁₂ used with all the rest of the 24 expansion battery cells 210″₁ . . . 210″₈, 212″₁ . . . 212″₈ and 214″₁ . . . 214″₈ to reach a mileage range thrice of that provided by the OFB cells 216″₁ . . . 216″₂. As illustrated by the shaded area in FIG. 2C, the modular battery cells may be added in all available expansion slots.

This type of addition as illustrated in FIG. 2C may provide 600 miles of total range using 36 modular battery cells, where 12 OFBs are connected in series and additional 24 RSBs may be connected in series with each other and in parallel to the OFBs. The additional 24 RSBs may be grouped further where each group of 12 RSBs may be connected in series within the group and in parallel with other groups. This connection and utilization of modular battery cells may be managed the BMS, which may be used to connect different modular battery cells in different combinations of series and/or in parallel connections as groups depending on the voltage configuration to form a battery pack unit capable of powering the electric vehicle.

The expansion battery cells, for example, 210₁ . . . 210₈, 212₁ . . . 212₈ and 214₁ . . . 214₈ may be connected in series with each other and in parallel with the original battery cells 216₁ . . . 216₁₂ which are connected in series with each other. Similarly, the additional batteries in the frunk and trunk may be connected within that portion in series but with others in parallel. The different configurations provided here are for examples only, and other configurations are also possible to provide similar functionality and are also within the spirit and scope of this invention.

The rechargeable modular battery cells 210₁ . . . 210₈, 212₁ . . . 212₈, and/or 212₁ . . . 212₈ may be connected in different combinations of series and/or in parallel connections as groups depending on the voltage configuration to form a battery pack unit capable of powering the electric vehicle.

In an embodiment, for example, as illustrated in FIG. 2D, in one or more embodiments, each of the one or more modular battery cells 210″₁ . . . 210″₁₀ is removably attached to one or more of the other modular battery cells in series via a central busbar 222″.

The rechargeable modular battery cells 210′″₁ . . . 210′″₁₀, and/or the rechargeable modular battery cells provided in the cavities in the frunk and/or trunk may be connected in different combinations of series and/or in parallel connections as groups depending on the voltage configuration to form a battery pack unit capable of powering the electric vehicle.

FIGS. 3A and 3B illustrate three-dimensional views of example system component 300 and 300′ for providing mileage range extension for an electric vehicle using rechargeable modular battery cells according to one or more embodiments described herein. For example, as illustrated in FIGS. 3A and 3B, the frame 304 or 304′ may be provided with one or more lockable access doors 326₁, 326₂ or 326′ that allow access to a single modular battery cell, or a group of modular battery cells, placed in shelflike cavities 306₁ . . . 306₈ or 306′₁ . . . 306′₂₀.

In any one or more embodiments described herein, the lockable access door 326₁ or 326′ may be provided as a pullout door or a swing door 326₁ or 326′ as illustrated in FIGS. 3A and 3B.

In any one or more embodiments described herein, the lockable access door 326₁ or 326′ may allow access to a single rechargeable modular battery cell or a group of rechargeable modular battery cells placed in the shelflike cavities, also referred to herein as expansion slots 306₁ . . . 306₈ or 306′₁ . . . 306′₂₀ respectively, from either side of the vehicle chassis, in the frunk and trunk.

In any one or more embodiments described herein, the lockable access door 326₁ or 326′ may allow access to a group of rechargeable modular battery cells placed in the shelflike cavities (expansion slots) 306₁ . . . 306₈ or 306′₁ . . . 306′₂₀ respectively, from front or back of the vehicle.

In any one or more embodiments, the expansion slots, also referred to herein as shelflike cavities, may be provided with one or more connection points including any one or more of: positive connection point 318₁, negative connection point 318₂, battery management system (BMS) connection point 318₃, and balance connection point 318₄ as illustrated in FIG. 3A. Although the connection points are shown on or near the doors, they could be placed anywhere as per manufacturer's configuration, such that they provide easy access for connecting and disconnecting the modular battery cells with the other components of the system.

Any one or more of the connection points similar to the ones illustrated in FIG. 3A and described herein may also be provided for the embodiment illustrated in FIG. 3B.

The various connection points may be used to connect the modular battery cells with each other and with the vehicle, for example, to connect each of the one or more rechargeable modular battery cells to any one or more of: one or more of the other rechargeable modular battery cells, central busbar, BMS, etc., which may be managed by BMS. The BMS may be used to connect different modular battery cells in different combinations of series and/or in parallel connections as groups depending on the voltage configuration to form a battery pack unit capable of powering the electric vehicle.

The balance connection point may be used to connect the modular battery cells with BMs and other components of the BMS, for example, voltage sensor and temperature sensor, etc. For example, each LFP modular battery cells 306₁ . . . 306₈ or 306′₁ . . . 306′₂₀ may be further constructed by 16 smaller or mini battery cells, each with nominal voltage, for example, 3.2-volt, and range between 100 amp to 300 amp. Each of the smaller/mini nominal voltage cells may have a smaller variance in voltage, however, the voltage of smaller/mini cells is supposed to be as close to each other as possible when fully charged. When this variance crosses a certain pre-determined threshold, they are to be balanced back. This may be done as a part of the BMS, where each smaller/mini modular battery cell is connected to the temperature and voltage sensor so that each cell could communicate with each other. The smaller/mini cells also need to talk to each other to get balanced. The connection for this communication may be provided by using the balance connection point.

The modular battery cell connection to the BMS also provides connection to the CPU of the electric vehicle for battery management.

Although, LFP battery is used as an example for providing explanation here, use of other types of batteries, for example, sodium batteries, semi-solid state or solid-state batteries, etc., is also possible and is within the spirit and scope of this invention. Similarly, although the use of 3.2-volt mini batteries is used as an example, and batteries with other voltages/amperages may also be used and is within the spirit and scope of this invention.

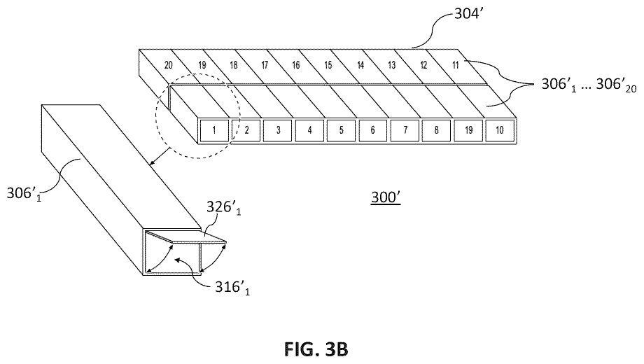

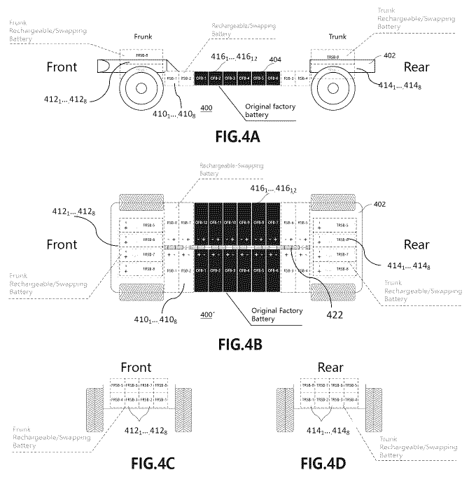

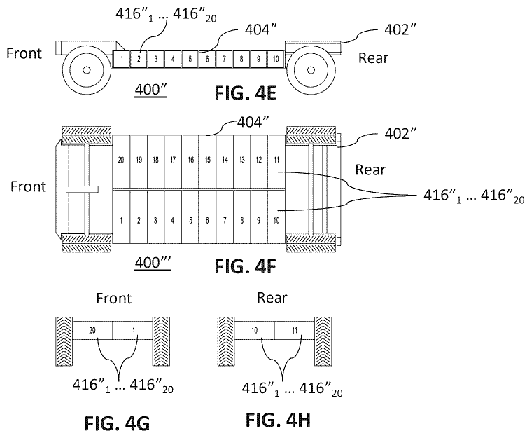

FIGS. 4A-4D illustrate example system components for providing mileage range extension for an electric vehicle using rechargeable modular battery cells according to one or more embodiments described herein. For example, FIG. 4A illustrates a side view of an electric vehicle cavity frame 404 holding 8 rechargeable modular battery cells in a single layer 410₁ . . . 410₈ on each side of the vehicle 402 and

FIG. 4B illustrates a top view of an electric vehicle cavity frame 404 holding 8 rechargeable modular battery cells 410₁ . . . 410₈ in cavities 406₁ . . . 406₈, shown in a single layer, respectively on each side of the vehicle 402.

FIGS. 4C and 4D illustrates a front and/or back view of an electric vehicle cavity frame 404 holding 8 rechargeable modular battery cells 412₁ . . . 412₈ and 414₁ . . . 414₈ in two layers respectively in the cavities or extension slots in the frunk and in the trunk respectively of the vehicle 402. Although the FIGS. 4C and 4D illustrate front and back of the vehicle, since the modular battery cells may be numbered in a various configuration, this illustration is provided as an example only, and other numbering and arrangements of those modular battery cells that serve the function similar to the one described here is also within the spirit and scop of this invention.

Although, one or two layers are shown in the figures, they are shown an examples only, and any number of layers and different combinations of number of layers possible depending on the height of the modular battery cells as well as the available space, and that is also within the spirit and scope of this invention.

FIGS. 4E-4H illustrate example system components for providing mileage range extension for an electric vehicle using rechargeable modular battery cells according to one or more embodiments described herein. For example, FIG. 4E illustrates a side view of an electric vehicle cavity frame 404″ holding 10 rechargeable modular battery cells 410″₁ . . . 410″₁₀ on each side of the vehicle 402″.

FIG. 4F illustrates a top view of an electric vehicle cavity frame 404 holding 10 rechargeable modular battery cells 410″₁ . . . 410″₁₀ in cavities 406″₁ . . . 406″₁₀ respectively on each side of the vehicle 402″.

FIGS. 4G and 4H illustrates a front and/or back view of an electric vehicle cavity frame 404″ holding 10 rechargeable modular battery cells 410″₁ . . . 410″₁₀ in cavities 406″ . . . 406″₁₀ respectively on each side of the vehicle 402″. Although the FIGS. 4C and 4D illustrate front and back of the vehicle, since the modular battery cells may be numbered in a various configuration, this illustration is provided as an example only, and other numbering and arrangements of those modular battery cells that serve the function similar to the one described here is also within the spirit and scop of this invention.

Although, numbering of the modular battery cells is described here as 1-12 or 18 in that order, any other number of battery cells and expansion slots or shelflike cavities and various other arrangements of those battery cells and expansion slots or shelflike cavities that serve the function similar to the one described here is within the spirit and scop of this invention.

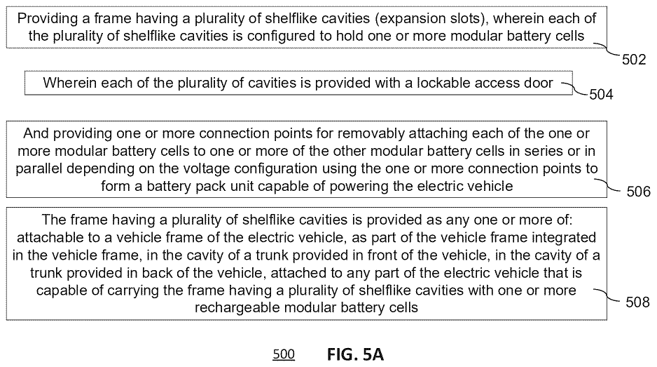

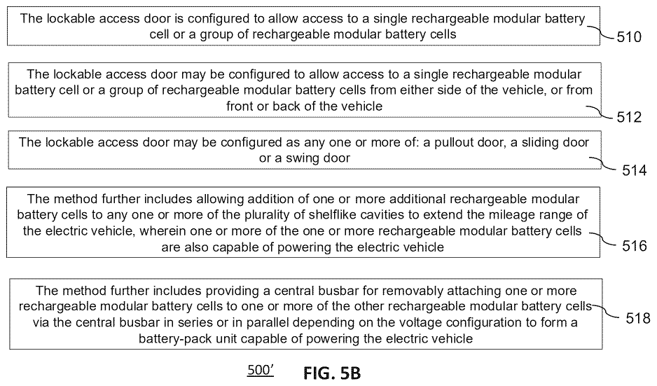

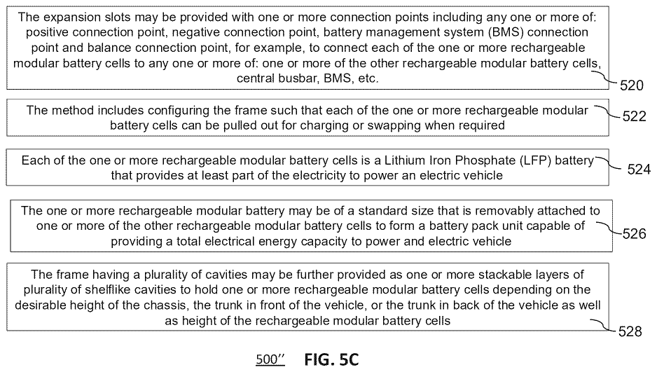

FIGS. 5A, 5B and 5C illustrate example methods 500, 500′ and 500″ for providing mileage range extension for an electric vehicle using rechargeable modular battery cells, according to one or more embodiments described herein. For example, as illustrated in FIG. 5A, in one or more embodiments, the method for providing mileage range extension for an electric vehicle using rechargeable modular battery cells includes providing a frame, having a plurality of shelflike cavities (expansion slots) configured to hold one or more rechargeable modular battery cells via step 502, wherein each of the plurality of cavities (expansion slots) is provided with a lockable access door via step 504; and providing one or more connection points for removably attaching each of the one or more rechargeable modular battery to one or more of the other rechargeable modular battery cells in series or in parallel depending on the voltage configuration, for example, using positive connection point and/or negative connection points, to form a battery pack unit capable of powering the electric vehicle via step 506.

In any one or more embodiments described herein, the frame having a plurality of shelflike cavities is provided as any one or more of: attachable to a vehicle frame of the electric vehicle, as part of the vehicle frame integrated in the vehicle frame, in the cavity of a trunk provided in front of the vehicle, in the cavity of a trunk provided in back of the vehicle, attached to any part of the electric vehicle that is capable of carrying the frame having a plurality of shelflike cavities with one or more rechargeable modular battery cells via step 508.

In any one or more embodiments described herein, the lockable access door may be configured to allow access to a single rechargeable modular battery cell or a group of rechargeable modular battery cells via step 510.

In any one or more embodiments described herein, the lockable access door is configured to allow access to a single rechargeable modular battery cell or a group of rechargeable modular battery cells from either side of the vehicle, or from front or back of the vehicle via step 512.

In any one or more embodiments described herein, the lockable access door may be configured as any one or more of: a pullout door, a sliding door or a swing door via step 514.

In any one or more embodiments described herein, the method further includes allowing addition of one or more additional rechargeable modular battery cells to any one or more of the plurality of shelflike cavities to extend the mileage range of the electric vehicle, wherein one or more of the one or more rechargeable modular battery cells are also capable of powering the electric vehicle via step 516.

In any one or more embodiments described herein, the method further includes providing a central busbar for removably attaching one or more rechargeable modular battery cells to one or more of the other rechargeable modular battery cells via the central busbar in series or in parallel depending on the voltage configuration to form a battery-pack unit capable of powering the electric vehicle via step 518.

In any one or more embodiments described herein, the expansion slots, also referred to herein as shelflike cavities, may be provided via step 520 with one or more connection points including any one or more of: positive connection point, negative connection point, battery management system (BMS) connection point, and balance connection point as illustrated in FIG. 3A and described in detail in the description accompanying FIG. 3A. The various connection points may be used to connect the modular battery cells with each other and with the vehicle, for example, to connect each of the one or more rechargeable modular battery cells to any one or more of: one or more of the other rechargeable modular battery cells, central busbar, BMS, etc., which may be managed by BMS. The BMS may be used to connect different modular battery cells in different combinations of series and/or in parallel connections as groups depending on the voltage configuration to form a battery pack unit capable of powering the electric vehicle.

In any one or more embodiments described herein, the method includes configuring the frame such that each of the one or more rechargeable modular battery cells can be pulled out for charging or swapping when required via step 522.

In any one or more embodiments described herein, each of the one or more rechargeable modular battery cells is a Lithium Iron Phosphate (LFP) battery that provides at least part of the electricity to power an electric vehicle via step 524.

Although, LFP battery is used as an example for providing explanation here, use of other types of batteries, for example, sodium batteries, semi-solid state or solid-state batteries, etc., is also possible and is within the spirit and scope of this invention.

In any one or more embodiments described herein, the one or more rechargeable modular battery may be of a standard size, including any one or more of: dimensions, voltage, capacity grade, etc. that is removably attached to one or more of the other rechargeable modular battery cells to form a battery pack unit capable of providing a total electrical energy capacity to power and electric vehicle via step 526.

In any one or more embodiments described herein, the frame having a plurality of cavities may be further provided as one or more stackable layers of plurality of shelflike cavities to hold one or more rechargeable modular battery cells depending on the desirable height of the chassis, the trunk in front of the vehicle, or the trunk in back of the vehicle as well as height of the rechargeable modular battery cells via step 528.

A person skilled in the art may readily understand that although a 48V with 100 Ah 5.12 KWH battery cell is used as examples for calculations here, other batteries providing similar functionality, for example, battery cells holding 5 kWh-15 kWh may also be used and such use is within the spirit and scope of this invention.

Although the use of 48-volt batteries is used as an example, and batteries with other voltages/amperages may also be used and is within the spirit and scope of this invention.

In any one or more embodiments described herein, the one or more rechargeable modular battery cells may be removably attached to one or more of the other modular battery cells in series, for example, 12 OFB modular battery cells, which may be provided as original factory battery cells when the vehicle was purchased, where each module or modular battery cell is a 48-volt LFP may be configured in series to form a 576-volt battery capable of providing a total electrical energy capacity of 62 kWh. With all expansion slots or cavities provided in this example filled, max capacity may be increased to 184 KWH

In any one or more embodiments described herein, the one or more modular battery cells, which may be provided by the vehicle manufacturer when the vehicle was purchased, also referred to herein as original modular battery cells, may be removably attached to one or more of the other rechargeable modular battery cells in series, for example, 12 modular battery cells, where each module or modular battery cell is a 48-volt LFP may be configured to form a 576-volt battery capable of providing a total electrical energy capacity of 62 kWh.

Thus, in any one or more embodiments described herein, one or more additional rechargeable modular battery cells can be added to any one or more of the plurality of shelflike cavities (expansion slots) to extend range of the electric vehicle via step 528, wherein each one of the battery-pack including one or more rechargeable modular battery cells, which may be provided by the vehicle manufacturer when the vehicle was purchased is also capable of powering the electric vehicle.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, etc. are intended to be inclusive, interchangeable, and/or synonymous with one another and other similar equipment for purposes of the present invention though one will recognize that functionally each may have unique characteristics, functions and/or operations which may be specific to its individual capabilities.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

We claim

1. A system for providing mileage range extension for an electric vehicle using one or more rechargeable modular battery cells, wherein the system comprises:
a frame having a plurality of shelflike cavities, wherein each of the plurality of shelflike cavities is configured to hold one or more rechargeable modular battery cells, and wherein each of the plurality of shelflike cavities comprises a lockable access door;
wherein each of the plurality of shelflike cavities is provided with one or more connection points; and
wherein each of the one or more rechargeable modular battery cells is removably attached to one or more of the other rechargeable modular battery cells in series or in parallel depending on the voltage configuration using the one or more connection points to form a battery-pack unit capable of powering the electric vehicle.

2. The system of claim 1, wherein the frame having a plurality of shelflike cavities comprises any one or more of: attachable to a vehicle frame of the electric vehicle, as part of the vehicle frame integrated in the vehicle frame, in the cavity of a trunk provided in front of the vehicle, in the cavity of a trunk provided in the back of the vehicle, attached to any part of the electric vehicle that is capable of carrying the frame having a plurality of shelflike cavities with one or more rechargeable modular battery cells.

3. The system of claim 1, wherein the one or more connection points include any one or more of: positive connection point, negative connection point, battery management system (BMS) connection point and balance connection point, to connect each of the one or more rechargeable modular battery cells to any one or more of: one or more of the other rechargeable modular battery cells, central busbar and BMS.

4. The system of claim 1, wherein the lockable access door is configured to allow access to a single rechargeable modular battery cell or a group of rechargeable modular battery cells from either side of the vehicle, or from front or back of the vehicle.

5. The system of claim 1, wherein the lockable access door comprises any one or more of: a pullout door, a sliding door or a swing door.

6. The system of claim 1, wherein one or more additional rechargeable modular battery cells can be added to any one or more of the plurality of shelflike cavities to extend the mileage range of the electric vehicle, wherein one or more of the one or more rechargeable modular battery cells are also capable of powering the electric vehicle.

7. The system of claim 1, wherein the one or more rechargeable modular battery cells is removably attached to one or more of the other rechargeable modular battery cells via a central busbar in series or in parallel depending on the voltage configuration to form a battery-pack unit capable of powering the electric vehicle.

8. The system of claim 1, wherein each of the one or more rechargeable modular battery cells is capable of being pulled out for charging or swapping when required.

9. The system of claim 1, wherein the one or more rechargeable modular battery cells comprise of a standard size including any one or more of: dimension, voltage, capacity grade, that is removably attached to one or more of the other rechargeable modular battery cells to form a battery pack unit capable of providing a total electrical energy capacity to power and electric vehicle.

10. The system of claim 1, wherein the system further comprises one or more stackable layers of plurality of shelflike cavities to hold one or more rechargeable modular battery cells depending on the desirable height of the chassis, the trunk in front of the vehicle or the trunk in the back of the vehicle as well as height of the rechargeable modular battery cells.

11. A method for providing mileage range extension for an electric vehicle using one or more rechargeable modular battery cells, wherein the method comprises:
providing a frame having a plurality of shelflike cavities, wherein each of the plurality of shelflike cavities is configured to hold one or more rechargeable modular battery cells, and wherein each of the plurality of shelflike cavities comprises a lockable access door; and
providing one or more connection points for removably attaching each of the one or more rechargeable modular battery cells to one or more of the other rechargeable modular battery cells in series or in parallel depending on the voltage configuration to form a battery-pack unit capable of powering the electric vehicle.

12. The method of claim 11, wherein the frame having a plurality of shelflike cavities is provided as any one or more of: attachable to a vehicle frame of the electric vehicle, as part of the vehicle frame integrated in the vehicle frame, in the cavity of a trunk provided in front of the vehicle, in the cavity of a trunk provided in back of the vehicle, attached to any part of the electric vehicle that is capable of carrying the frame having a plurality of shelflike cavities with one or more rechargeable modular battery cells.

13. The method of claim 11, wherein each of the plurality of shelflike cavities is provided with one or more connection points including any one or more of: positive connection point, negative connection point, battery management system (BMS) connection point and balance connection point, to connect each of the one or more rechargeable modular battery cells to any one or more of: one or more of the other rechargeable modular battery cells, central busbar and BMS.

14. The method of claim 11, wherein the lockable access door is configured to allow access to a single rechargeable modular battery cell or a group of rechargeable modular battery cells from either side of the vehicle, or from front or back of the vehicle.

15. The method of claim 11, wherein the lockable access door comprises any one or more of: a pullout door, a sliding door or a swing door.

16. The method of claim 11, wherein the method further comprises allowing addition of one or more additional rechargeable modular battery cells to any one or more of the plurality of shelflike cavities to extend the mileage range of the electric vehicle, wherein one or more of the one or more rechargeable modular battery cells are also capable of powering the electric vehicle.

17. The method of claim 11, wherein the method further comprises providing a central busbar for removably attaching one or more rechargeable modular battery cells to one or more of the other rechargeable modular battery cells via the central busbar in series or in parallel depending on the voltage configuration to form a battery-pack unit capable of powering the electric vehicle.

18. The method of claim 11, comprising configuring the frame such that each of the one or more rechargeable modular battery cells can be pulled out for charging or swapping when required.

19. The method of claim 11, wherein the one or more rechargeable modular battery cells comprise of a standard size including any one or more of: dimensions, voltage, capacity grade, that is removably attached to one or more of the other rechargeable modular battery cells to form a battery pack unit capable of providing a total electrical energy capacity to power and electric vehicle.

20. The method of claim 11, the frame having a plurality of cavities is further provided as one or more stackable layers of plurality of shelflike cavities to hold one or more rechargeable modular battery cells depending on the desirable height of the chassis, the trunk in front of the vehicle, or the trunk in back of the vehicle as well as height of the rechargeable modular battery cells.
